(19) United States
(12) Patent Application Publication
(10) Pub. No.: US 2026/0018076 A1
(43) Pub. Date: Jan. 15, 2026

(54) PERSONALIZED LEARNING SYSTEM USING A SOCIAL MEDIA STYLE USER INTERFACE

(71) Applicant: 2hr Learning, Inc., Austin, TX (US)

(72) Inventors: Philip Hewinson, Austin, TX (US); Samy Aboel-Nil, Austin, TX (US); Joe Liemandt, Austin, TX (US)

(73) Assignee: 2hr Learning, Inc., Austin, TX (US)

(21) Appl. No.: 19/269,603

(22) Filed: Jul. 15, 2025

Related U.S. Application Data
(60) Provisional application No. 63/671,749, filed on Jul. 15, 2024.

(51) Int. Cl. G09B 5/12

(52) U.S. Cl. CPC G09B 5/12

(57) ABSTRACT

The system and method combine programmatic control and a guided and constrained Artificial Intelligence (AI) engine to deliver educational content to users through a social media-style user interface is disclosed. The personalized learning system includes one or more processors and memory operatively coupled to the processors, executing code to perform various operations. The personalized learning system integrates a social media style user interface within an online learning platform, featuring swipeable vertically browsing content and interactive buttons like likes, dislikes, comments, shares, and bookmarks to enhance user engagement. The personalized learning system collects user profile details and engagement data based on which a prompt is generated for an AI engine. Under the control of programmatic logic, the AI engine uses these prompts to generate customized learning paths and content feeds, prioritizing content with the highest engagement scores. Personalized content feed is then displayed via the user interface, maintaining high user engagement.

### CROSS-REFERENCE TO RELATED APPLICATION(S)

This application claims the benefit under 35 U.S.C. § 119(c) and 37 C.F.R. § 1.78 of U.S. Provisional Application No. 63/671,749, which is incorporated by reference in its entirety.

### FIELD OF THE INVENTION

The present invention relates in general to the field of electronics, and more specifically to a system of providing personalized and dynamic educational content to a user using an online learning platform that includes a user interface that mimics social media patterns to provide personalized and adaptive learning to the user.

### BACKGROUND OF THE INVENTION

In recent years, education has experienced significant changes due to the arrival of Artificial Intelligence (AI). Traditional classrooms, where students and teachers interact face-to-face, are replaced by virtual classrooms accessed through the internet. Textbooks are replaced by digital resources, such as online articles, videos, and interactive apps. One of the most notable changes in education is the integration of social media into online learning. Social media platforms once used mainly for personal communication and entertainment, are now powerful tools for education and collaboration.

With the rise of remote learning, where students learn from home or other locations outside of a traditional classroom, and the development of AI, social media has become more crucial in education than before. These platforms expand the boundaries of the traditional classroom, allowing for a more connected and interactive learning experience. For example, teachers can use social media to create virtual classrooms. In these virtual spaces, they can share educational resources, conduct discussions, and provide real-time feedback to students. This makes learning more engaging and accessible, as students can participate in these activities from anywhere with an internet connection.

Beyond the virtual classroom, social media enables students to collaborate on projects, share ideas, and seek help from peers and experts around the world. Educational groups and forums on social media platforms allow students to join communities of interest, where they can discuss topics, ask questions, and access a wealth of information and resources. This connectivity breaks down geographical barriers, giving students access to diverse perspectives and expertise that enrich their learning experience. Additionally, these platforms offer educational content in various formats, such as tutorials, lectures, and live streams, catering to different learning styles and preferences.

Traditional educational technology often lacks the engagement and interactivity that students are accustomed to on social media platforms. Conventional e-learning systems typically present content in static, long-form formats, which do not align with the fast-paced, interactive media that students engage with daily. Also, educational platforms have attempted to engage students through various means such as gamification, multimedia content, and interactive quizzes. While these methods are somewhat effective, they may not fully leverage the habitual behaviors and preferences developed from social media use.

Furthermore, the conventional one-size-fits-all approach to curriculum delivery does not account for individual learning styles, preferences, and mastery levels. Traditional e-learning platforms often fall short because they lack the interactive and engaging elements of social media, which can lead to lower user engagement and retention rates. Gamified learning applications, although they incorporate elements of interactivity, may not provide the same level of social interaction and can become repetitive or less engaging over time. Similarly, video-based learning platforms offer limited interactivity and personalization, leading to a passive learning experience where students are mere recipients of information rather than active participants.

### SUMMARY

In at least one embodiment, a method for providing educational content to a user using a social media style user interface including executing code using one or more processors of a computer system to cause the computer system to perform operations including integrating social media style user interface to an online learning platform for enhancing user engagement by including short content feed that are displayed to the user in the form of a swipeable vertically browsing content item and incorporating buttons like liking, disliking, commenting, sharing, and bookmarking for providing an interaction between the user and the user interface. The method also includes accessing one or more user profile details available in a user profile and collecting the one or more user profile details and user engagement data. The one or more user profile details include user preferences, interests, historical data, educational goals, and topics of interest. The method further includes providing a customized content feed to the user by analyzing user engagement data and student performance to determine engagement patterns and mastery levels of the user. In addition, the method includes generating a customized learning path for each user based on the engagement patterns and mastery levels and identifying content feed for each user based on the highest engagement score. The engagement score is determined using frequency and type of the user engagement data. Finally, the method includes receiving the customized content feed that has a higher engagement score. The content that are highly engaging in the user's content feed are prioritized during the display.

In another embodiment, a system to guide and constrain an Artificial Intelligence (AI) engine to provide educational content to a user through a social media style user interface includes one or more processors. It also includes a memory, operatively coupled to the one or more processors consisting of one or more code that when executed cause the one or more processors to perform operations including integrating social media style user interface to an online learning platform for enhancing user engagement by including short content feed that are displayed to the user in the form of a swipeable vertically browsing content item and incorporating buttons like liking, disliking, commenting, sharing, and bookmarking for providing an interaction between the user and the user interface. The operations also include accessing one or more user profile details available in a user profile and collecting the one or more user profile details and user engagement data. The one or more user profile details include user preferences, interests, historical data, educational goals, and topics of interest. The operations further include providing a customized content feed to the user by analyzing user engagement data and student performance to determine engagement patterns and mastery levels of the user. In addition, the operations include generating a customized learning path for each user based on the engagement patterns and mastery levels and identifying content feed for each user based on the highest engagement score. The engagement score is determined using frequency and type of the user engagement data. Finally, the operations include receiving the customized content feed that has a higher engagement score. The content that is highly engaging in the user's content feed are prioritized during the display.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary personalized learning system using a social media style user interface.

FIG. 2 depicts an exemplary personalized learning process using the personalized learning system with social media style user interface.

FIG. 3 depicts a personalized content feed providing process, which is an embodiment of the personalized learning process using a social media style user interface of FIG. 2.

FIGS. 4 and 5 depict exemplary social media style user interface displays disclosing courses offered to the user and the option of selecting user objectives by the user while using an online learning platform.

FIG. 6 depicts an exemplary social media style user interface showing the course the user selects using an online learning platform.

FIG. 7 depicts an exemplary social media style user interface showing the user details and course management options to the user.

FIGS. 8 and 9 depict exemplary social media style user interface displays disclosing the unit-wise and topic-wise details of the educational content displayed to the user.

FIG. 10 depicts an exemplary social media style user interface showing the generated content item to the user using an online learning platform.

FIG. 11 depicts an exemplary social media style user interface display showing the option of sharing the content item feed with other users.

FIG. 12 depicts a personalized content feed generation process, which is an embodiment of the personalized learning process using a social media style user interface of FIG. 2.

FIG. 13 depicts a customized learning path generation process, which is an embodiment of the personalized learning process using a social media style user interface of FIG. 2.

FIG. 14 depicts a learning path display process, which is an embodiment of the personalized learning process using a social media style user interface of FIG. 2.

FIG. 15 depicts an adaptive and personalized learning content item display process on the social media style user interface, which is an embodiment of the personalized learning process using the social media style user interface of FIG. 2.

FIG. 16 depicts a social media style user interface initialization process, which is an embodiment of the personalized learning process using a social media style user interface 104 of FIG. 2.

FIG. 17 depicts a data structure for organizing data that is used to utilize a social media style user interface for user engagement.

FIG. 18 depicts a data structure for organizing data that is used to generate an adaptive learning path for personalizing the learning path of each user using an online learning platform.

FIG. 19 depicts an exemplary network environment in which the personalized learning system of FIG. 1 and the personalized learning process of FIG. 2 may be practiced.

FIG. 20 depicts an exemplary computer system.

### DETAILED DESCRIPTION

The personalized learning system and method set forth herein address technical issues with generating personalized educational content to a user through a social media style user interface described herein. Conventionally, manual processes were used to generate the personalized educational content and were very tedious and time consuming. The present personalized learning system and method utilize an automated system that does not merely automate a manual process or use a conventional system in a conventional way. The personalized learning system and method integrates programmatic processes with content generated by one or more artificial intelligence (AI) engines to present engaging educational content in a social media style presentation. Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the personalized learning systems and methods. For example, use of the term “invention” does not limit or require the referenced certain features to be present in all embodiments of the invention. Use of absolute-type terms, such as “required,” “must,” “only,” “important,” and so on are not limiting of all embodiments of the personalized learning systems and methods and not to be construed as limiting of the embodiments of the personalized learning systems and methods described above.

A personalized learning system utilizing an Artificial Intelligence (AI) engine to deliver personalized educational content to a user through a social media style user interface. The personalized learning system guides the AI engine to generate content item feeds based on engagement scores and relevancy of the content to the user. The engagement score is estimated based on the user's interaction with the content on an online learning platform, whereas the relevancy of the content is estimated based on the mastery of the user on various topics.

The user engages with the content on the online learning platform through interactive buttons provided via the social media type user interface. The interactive buttons allow the user to like, dislike, comment, share, and bookmark the displayed content. The engagement score for a particular content is high if user interaction with that content is high as compared to other content.

The social media style user interface includes certain features similar to those of social media platforms. These features include swipeable vertical feed including short content item feed and interactive buttons including like, share, comment, bookmark, and dislike allowing users to express their opinion on the generated content item feed.

The online learning platform is operatively coupled with an engagement and mastery analyzer including an engagement analyzer configured to collect user profile details, user engagement details, and user interaction details to analyze and generate insights. A prompt generator operatively coupled to the engagement and mastery analyzer generates a prompt leveraging Natural Language Processing techniques. The generated prompts are then shared with the AI engine for the generation of content item feed by calculating the engagement score and generating a personalized learning path for each user based on preferences, relevancy, and engagement of the user with the social media style user interface. The generated content feed is displayed to the user and keeps on updating to provide relevant and updated content feed to the user, thereby increasing the engagement level of the user.

The personalized learning system offers a significant advantage by merging the engaging elements of social media platforms with the online learning platform, thereby enhancing user engagement and learning effectiveness. By utilizing familiar social media style features and integrating the features within the user interface, including vertical swipeable feeds and interactive buttons such as likes, comments, and shares, the platform makes learning more engaging and enjoyable. The personalized approach not only increases the motivation and participation of the user but also ensures that educational content is dynamically adjusted to optimize learning outcomes, making the entire educational process more efficient and effective.

The personalized learning system integrates AI and social media features into the learning process to make learning better by personalizing content feeds for each user. It recommends materials based on a user's interests and progress, keeping them engaged. Such an AI-based personalized learning system may also provide insights to tutors based on which tutors can offer relevant support to users/students, thereby enhancing the learning performance of the user. The personalized learning system also helps teachers connect, share best practices, and stay updated on educational trends. Traditional learning methods don't engage students as much as social media based methods do, making the disclosed personalized learning system valuable.

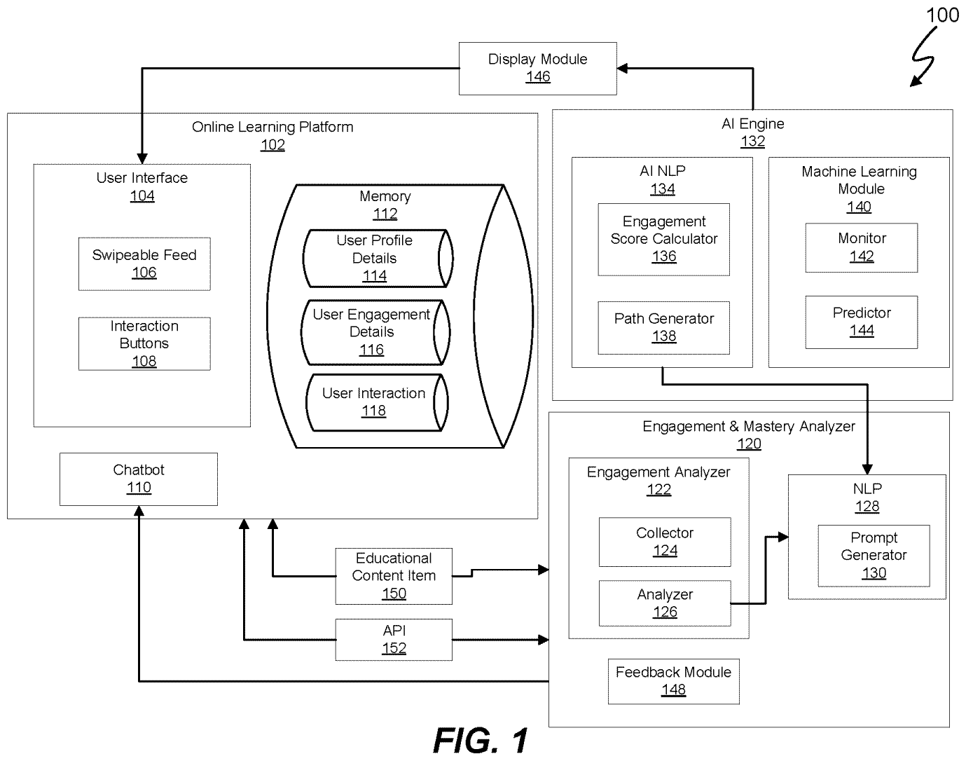

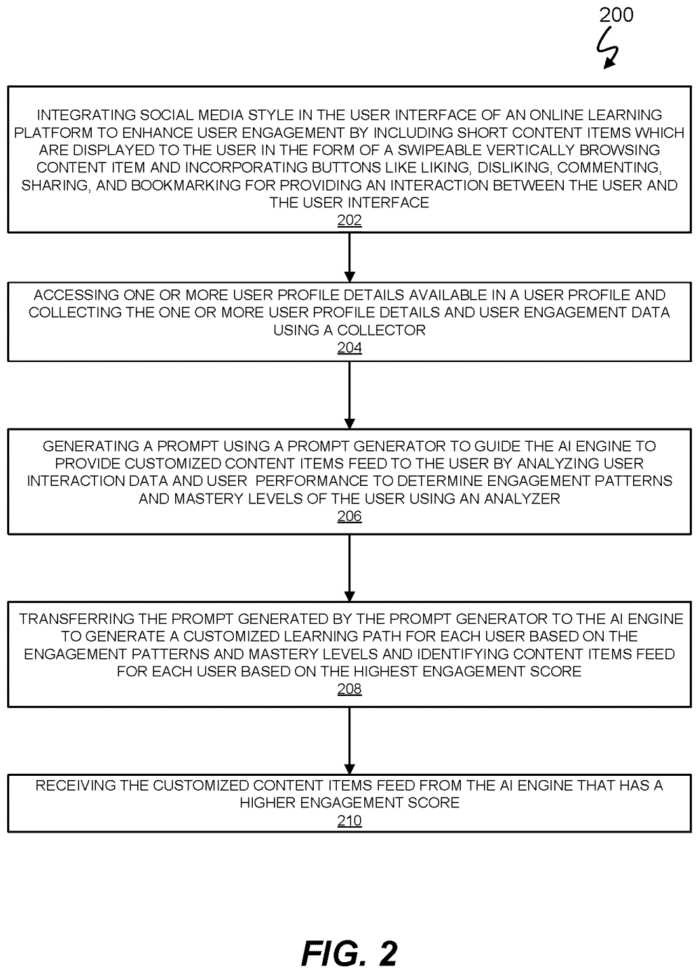

FIG. 1 depicts an exemplary personalized learning system 100 using a social media style user interface 104. FIG. 2 depicts an exemplary personalized learning process 200 using a social media style user interface 104 utilized by the personalized learning system 100. Referring to FIGS. 1 and 2, in operation 202, the social media style user interface 104 is integrated into an online learning platform 102 to enhance user engagement. The social media style user interface 104 is configured to display short content items (may also be referred to as ‘content feed’ or ‘content’) to the user in the form of swipeable vertically-browsing content items.

The personalized learning system 100 utilizes AI engine 132 to generate the content feed to be displayed to the user via the social media style user interface 104. The content is provided in the form of a vertically swipeable feed 106, where initializing the feed includes storing educational content items 150 in an empty feed list. This empty feed list serves as a dynamic container that is populated with educational content items 150 fetched from an Application Programming Interface (API) 152. The fetched educational content item 150 is then organized into this empty list, ensuring it is readily available for display. Once the list is populated, the content items are presented in a vertical feed, allowing users to browse through them by swiping vertically, mimicking social media platforms such as TikTok and others.

The retrieval of educational content item 150 from the API 152 to populate the swipeable vertical feed 106 involves sending a command to the API 152 from the online learning platform 102 to collect the educational content item 150 from the engagement and mastery analyzer 120. The engagement and mastery analyzer 120 provides the educational content 150 via the API 152 which is further processed and provided to the user via the user interface 104. The educational content items are formatted and made visually and functionally compatible with the user interface 104, ensuring a seamless user experience. After formatting, the educational content items 150 are integrated into the personalized learning path and the swipeable vertical feed 106 on the user interface 104.

The codes and functions mentioned in the pseudo-code of the personalized learning system 100 using a social media style user interface 104 to initialize the user interface 104 and create a vertical swipeable feed 106 is explained below in correspondence to the above mentioned details.

The ‘initialize_social_media_ui’ function sets up the main interface resembling a social media feed. It creates a vertical swipeable feed 106 using ‘create_vertical_feed’ and enhances it with social interaction buttons 108 (like, bookmark, share, and comment) to increase user engagement. The function then returns this interactive feed. The ‘create_vertical feed’ function initializes an empty list called ‘content_items’ to store content. It fetches content from an external source using ‘fetch_content_from_api’ and populates ‘content_items’ with the fetched content, ultimately returning the list of content items.

To enhance user interaction and engagement, the user interface 104 provides interactive buttons 108 such as like, dislike, comment, share, and bookmark on each content item page. The buttons 108 enable users to engage with the content actively, providing feedback and sharing their opinions or preferences. The use of these interactive features makes the user interface 104 more engaging. By integrating the vertical swipeable feed 106 and the interactive buttons 108, the method ensures that the educational content is not only easily accessible but also engaging and interactive, promoting higher user engagement and satisfaction.

Further, the user can also interact with the online learning platform 102 using the chatbot 110 integrated within the user interface 104. The user may ask a query or share his feedback using the chatbot 110.

In operation 204, a collector integrated into an engagement analyzer 122 accesses the user profile details 114 stored in the memory 112 of the online learning platform 102. The collector 124 collects one or more user profile details 114 and user engagement details 116. The one or more user profile details 114 include user preferences, interests, historical data, educational goals, and topics of interest. The user engagement details 116 include user actions including likes, bookmarks, shares, dislikes, and comments on the content items displayed to the user via the social media style user interface 104.

The codes and functions mentioned in the pseudo-code of the personalized learning system 100 using a social media style user interface 104 to fetch and simulate the content from the API 152 is explained below in correspondence to the above mentioned details.

The ‘fetch_content_from_api’ function serves as a placeholder for an actual API call. It calls ‘api_call_to_fetch_content’ to get the content, which it then returns. This function simulates interaction with the engagement and mastery analyzer 120 to retrieve content. The ‘api_call_to_fetch_content’ function simulates the process of fetching content from a backend service. It returns a predefined list of content items, representing the educational content available to users. In the_main_block, the ‘initialize_social media_ui’ function is called to set up the UI. The resulting vertical swipeable feed 106 is then displayed to the user using ‘display_ui (social_media_ui)’.

In operation 206, a prompt generator 130 utilizes Natural Language Processing techniques using a Natural Language Processor 128 (NLP) to guide and constrain the AI engine 132 to provide customized and personalized content feed to the user. An analyzer 126 analyzes the user interaction data 118 and user performance to determine engagement patterns and mastery levels of the user. The analyzer 126 is integrated within the engagement analyzer 122.

The prompt generator 130 generated the prompt that guide and constrain the AI engine 132. The prompt generator 130 is integrated within the engagement and mastery analyzer 120 and is operatively coupled to the AI engine 134. The prompt generator 130 generates prompts based on an analysis of user interactions 118, including likes, dislikes, comments, shares, and bookmarks. This analysis helps identify patterns of user engagement with the content feed. For example, if a user frequently likes and shares science content but rarely engages with math content, the analyzer 126 will note this pattern and guide the prompt generator 130 to generate prompts allowing the AI engine 132 to generate more science-related content.

Additionally, the prompt generator 130 evaluates user's performance based on metrics such as quiz scores and completion rates to determine their mastery level on each topic. For instance, a user who consistently scores high on mathematics quizzes but struggles with history is identified to have a higher mastery level in mathematics.

The prompt generator 130 can dynamically adjust the prompt generation based on real-time user interaction and feedback. This dynamic adjustment ensures that the prompts remain relevant and effective in guiding accordingly as the AI engine 132. For example, if a user suddenly starts engaging more with a new type of content, the prompt generator will incorporate this change in real-time to adjust the content feed accordinglyas having. This ensures that the AI engine 132 continuously provides the most relevant, engaging, and updated content, enhancing the learning experience for each user.

The AI engine 132 further utilizes a feedback loop 148 that incorporates sentiment analysis of user actions on the content items feed. This feedback loop 148 is essential for understanding how users feel about the content they interact with and enhancing the personalization of their learning experience. The Natural Language Processing (NLP) techniques are utilized to analyze the sentiments expressed by users in their comments, likes, shares, and dislikes. For example, a user might leave a positive comment or like a video, indicating satisfaction, while a dislike or negative comment may suggest dissatisfaction.

Once the sentiments are analyzed, insights are generated based on these user actions. The generated insights provide valuable insights about the user's emotional response to the content, helping to understand what type of content resonates well with the user. For instance, if the analysis reveals that the user is consistently leaving positive comments and likes on interactive quizzes but engaging less on long-form articles, this insight will be used to adjust the content feed to have more quiz-based content displayed to the user as compared to the long-form articles.

The above-generated insights are thus utilized by the AI engine 132 to provide relevant content feed to the user. The AI engine 132 refines and updates the content feed in real-time based on received insights, thus ensuring that the user receives content they enjoy and engage with positively. Therefore, the feedback loop 148 helps in maintaining high levels of user engagement and satisfaction.

In operation 208, the prompt generator 130 transfers the generated prompts to the AI engine 132. The path generator 138 integrated within the AI engine 132 utilizes natural language processing techniques to generate a personalized and customized learning path for each user based on the engagement patterns and mastery levels. The AI engine 132 further identifies content feed for each user based on the highest engagement score. The engagement score calculator 136 determines the engagement score of the user interaction and engagement details 116.

The codes and functions mentioned in the pseudo-code of the personalized learning system 100 using a social media style user interface 104 to personalize the learning path based on user enaggement and mastery is explained below in correspondence to the above mentioned details.

The ‘personalize_learning_path’ function takes a ‘user_id’ as input and personalizes the user's learning path based on their engagement and mastery levels. It retrieves engagement data through ‘get_engagement_data’ and mastery data via ‘get_mastery_data’, then uses these datasets to generate a personalized learning path with ‘generate_learning_path’. The function returns the personalized path.

The engagement score calculator 136 calculates the engagement score of the user by monitoring user interactions 118 such as likes, dislikes, bookmarks, shares, and comments on the content items feed. These actions are recorded, noting both their frequency and type for each piece of content. For example, a particular video lesson might receive numerous likes and comments but few shares or bookmarks. Based on this, the personalized learning system 100 assigns weights to different types of user interactions 118. For instance, the weight assigned to a comment might be higher as compared to a like.

For example, the pseudo-code given below depicts the weights for each user interaction 118 i.e., 10 score for a Like, 5 score for Bookmark, 3 score for Share, and 7 score for a Comment. These weights are not static, they are adjusted dynamically based on historical engagement data and user feedback.

The personalized learning system 100 also analyzes the frequency and recency of user interactions 118 to assess the engagement level. For instance, if a user liked a content item recently, this interaction is weighted more heavily than a like from a few months ago. This helps in understanding the current engagement level of the user.

The codes and functions mentioned in the pseudo-code of the personalized learning system 100 using a social media style user interface 104 to retrieve user engagement data 116 and mastery level is explained below in correspondence to the above mentioned details.

The ‘get_engagement_data’ function fetches user engagement data 116 from a database or API 152, returning a dictionary with metrics such as likes, bookmarks, shares, and comments. This data reflects the user's interaction with the content. The ‘get_mastery_data’ function retrieves the user's proficiency levels across different subjects from a database or API 152, returning a dictionary that indicates the user's mastery in subjects like math and science.

AI NLP techniques are integral to determining the engagement score and assessing the mastery levels of the user. These techniques are utilized by AI NLP 134 to analyze historical user actions, such as likes, dislikes, comments, shares, and bookmarks, to identify patterns of the user engagement details 116. Additionally, the AI NLP 134 tracks performance metrics like quiz scores, completion rates, and proficiency on specific topics or skills to assess user mastery levels. For example, if a student consistently scores high on math quizzes but struggles with science, the personalized learning system 100 identifies that the student needs more attention in science.

Using these insights, the prompt generator 130 generates prompts for the AI engine 132 by utilizing the NLP techniques using NLP 128 to create customized learning paths for each user. The content feed for each user is identified based on the highest engagement score and this information is transferred to the AI engine 132 for content recommendation. This ensures that highly engaging content is prioritized for display. The AI engine 132 also customizes the difficulty levels and topics based on the user's learning requirements, including mastery levels, learning goals, and performance in content items. For instance, a user proficient in basic algebra but struggling with advanced topics will receive more challenging algebra content to bridge the gap. AI NLP 134 refines these recommendations in real-time, ensuring the learning path remains personalized and effective. In at least one embodiment, “challenging” means content that meets or exceeds a student's objective, current educational mastery level. In at least one embodiment, the current educational mastery level is based on testing and/or completion of educational content. For example, when a student completes a particular activity, lesson, topic, and/or unit as referenced in Common Core State Standards or modifications thereof.

A path generator 138 operatively coupled to the AI engine 132 further enhances the content personalization by analyzing the user's current mastery levels across various topics through metrics like quiz score, test completion rate, and the time spent per session. The path generator 138 incorporates user preferences and interests to ensure the content is engaging. The difficulty level of the content items is adjusted based on the user's progress, keeping the material challenging yet achievable. This learning path is continuously updated in real-time based on ongoing user interactions and feedback, ensuring that the content remains relevant and engaging.

The codes and functions mentioned in the pseudo-code of the personalized learning system 100 using a social media style user interface 104 to generate the learning path is explained below in correspondence to the above mentioned details. The ‘generate_learning path’ function takes the user engagement data 116 and mastery data as input and uses an algorithm to create a personalized learning path. It returns a list of educational content items in correspondence to the user's needs and skill levels. In operation 210, a display module 146 displays the content feed received from the AI engine 132 via the user interface 104. The content item having a high engagement score is given preference for display via the social media style user interface 104. The codes and functions mentioned in the pseudo-code of the personalized learning system 100 using a social media style user interface 104 to display the generated response is explained below in correspondence to the above mentioned details.

In the_main_block, a user ID (user 123) is assumed, and the ‘personalize_learning_path’ function is called to generate a personalized learning path for this user. The generated learning path is then displayed to the user with ‘display_learning_path (learning_path)’.

The feedback module 148 is an integral component and is integrated within the engagement and mastery analyzer 120. The feedback module 148 is operatively coupled to the user interface 104. The feedback module 148 is designed to enhance user interaction and engagement within the social media style user interface 104 of the online learning platform 102. The feedback module 148 provides a seamless way for users to give feedback directly on the content items feed they interact with in the same way as that of the social media platforms. The feedback module 148 allows users to express their opinions, preferences, and suggestions through various means such as comments, ratings, and reactions (like, dislike, share, and bookmark). By enabling direct feedback, the feedback module 148 not only captures the real-time sentiments of the user but also promotes a sense of involvement and active participation. This direct line of communication between the user and the online learning platform 102 ensures that the content items feed can be continuously refined and updated in correspondence to meet the educational needs and preferences of each individual user. Additionally, the feedback collected is analyzed to generate insights into user engagement patterns and content effectiveness, which can be used to further personalize the learning experience.

The personalized learning system 100 is specifically designed to enhance user engagement by prioritizing and dynamically adjusting content items. The user interface 104 mimics the familiar social media platforms, where users can browse through content in a vertically swipeable feed 106. The personalized learning system 100 plays a crucial role in ensuring that the most recent and engaging content is featured at the top to keep users engaged.

Initially, the personalized learning system 100 prioritizes content items that have the highest engagement scores. These scores are calculated using the engagement score calculator 136 based on various user interactions 118 with the online learning platform 102 such as likes, comments, shares, and bookmarks. This prioritization ensures that users see the most relevant and popular content first, enhancing their overall experience and encouraging further interaction.

Moreover, the personalized learning system 100 dynamically adjusts the order of the content items based on the user's recent interactions. This means that the content items feed is continuously updated to reflect the latest and relevant user preferences. For instance, if a user recently interacted with content items related to transformer testing, the personalized learning system 100 will adjust the content items feed to show more content items related to the testing of transformers, maintaining a high level of relevance and engagement. This dynamic adjustment is crucial for keeping the user interested and engaged over time, as it ensures that the content presented is always aligned with their current interests and needs.

The personalized content feed displayed to the user, therefore, involves two key steps. Firstly, it prioritizes content items with the highest engagement scores to ensure that users are shown the most engaging content. Secondly, it adjusts the display order of these content items based on the user's recent interactions, ensuring that the feed remains dynamic and relevant. By incorporating these steps in a chronological order, the personalized learning system 100 using a social media style user interface 104 effectively enhances user engagement and satisfaction, making the learning experience more interactive and personalized.

In an embodiment, the personalized learning system 100 utilizes a machine learning module 140 to enhance the personalization and effectiveness of the online learning platform 102. The machine learning module includes two main components namely, monitor 142 and predictor 144. The monitor's role is to track user engagement details 116 over time and collect data on various user interactions 118, such as likes, comments, shares, bookmarks, and time spent on different content items. By analyzing this data, the personalized learning system 100 can identify changes in user behavior and preferences. For example, if a user frequently likes and comments on math-related content but rarely interacts with science-related content, the personalized learning system 100 will note this preference.

The predictor 144 uses machine learning algorithms to analyze the data collected by the monitor 142. It forecasts future user engagement patterns based on historical data and current trends. This allows the personalized learning system 100 to adapt content delivery strategies to better meet the user's needs and preferences. For instance, if the predictor 144 identifies a trend where users tend to engage more with interactive videos rather than text-based content, the personalized learning system 100 might prioritize delivering more video content. By continually adjusting the content based on real-time data and predictions, the online learning platform 102 ensures that users remain engaged and receive the most relevant and effective educational materials.

The pseudo-code for the personalized learning system 100 using a social media style user interface 104 is given below:

```
# Function to initialize the user interface with social media
features
def initialize_social_media_ui( ):
  # Create a vertical feed of swipeable content
  feed = create_vertical_feed( )
  # Add social interaction buttons like likes, bookmarks,
sharing, and commenting
  feed.add_interaction_buttons([‘like’, ‘bookmark’, ‘share’,
‘comment’])
  return feed
# Function to create a vertical feed of content
def create_vertical_feed( ):
  # Initialize an empty list to hold the content items
  content_items = [ ]
  # Fetch content from the database or API
  fetched_content = fetch_content_from_api( )
  # Populate the content_items list with fetched content
  for content in fetched_content:
    content_items.append(content)
  return content_items
# Function to fetch content from the database or API
def fetch_content_from_api( ):
  # Placeholder for API call to fetch content
  # Returns a list of content items
  return api_call_to_fetch_content( )
# Function to simulate an API call to fetch content
def api_call_to_fetch_content( ):
  # This function would interact with the backend to fetch
content
  # Returns a list of content items
  return [‘Content 1’, ‘Content 2’, ‘Content 3’]
# Main execution flow
if _{——}name_{——} == “_{——}main_{——}”:
  # Initialize the social media style UI
  social_media_ui = initialize_social_media_ui( )
  # Display the UI to the user
  display_ui(social_media_ui)
# Pseudo-code for Adaptive Learning Path Personalization Engine
# Function to personalize the learning path based on engagement
and mastery
def personalize_learning_path(user_id):
  # Retrieve user engagement data
  engagement_data = get_engagement_data(user_id)
  # Retrieve user mastery levels
  mastery_data = get_mastery_data(user_id)
  # Generate a personalized learning path
  personalized_path = generate_learning_path(engagement_data,
mastery_data)
  return personalized_path
# Function to retrieve user engagement data
def get_engagement_data(user_id):
  # Placeholder for database query or API call
  # Returns a dictionary of engagement metrics
  return {‘likes': 10, ‘bookmarks': 5, ‘shares': 3, ‘comments':
7}
# Function to retrieve user mastery levels
def get_mastery_data(user_id):
  # Placeholder for database query or API call
  # Returns a dictionary of mastery levels for different
subjects
  return {‘math’: ‘intermediate’, ‘science’: ‘advanced’}
# Function to generate a learning path based on engagement and
mastery
def generate_learning_path(engagement_data, mastery_data):
  # Placeholder for algorithm to generate learning path
  # Returns a list of educational content items
  return [‘Math Content 1’, ‘Science Content 2’]
# Main execution flow
if _{——}name_{——} == “_{——}main_{——}”:
  # Assume a user ID is provided
  user_id = ‘user123’
  # Personalize the learning path for the user
  learning_path = personalize_learning_path(user_id)
  # Display the personalized learning path to the user
  display_learning_path(learning_path)
```

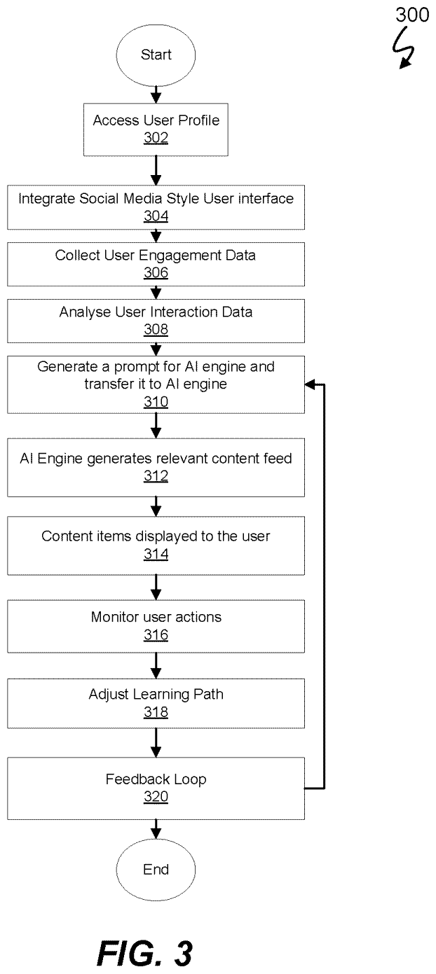

FIG. 3 depicts a personalized content feed providing process 300 to a user via a social media style user interface 104, which is an embodiment of the personalized learning process 200 using a social media style user interface 104 of FIG. 2. The personalized content feed providing process 300 starts by accessing the user profile 302 to gather user profile details 114 stored in the memory 112. This involves retrieving user preferences, interests, historical data, educational goals, and topics of interest in correspondence to the learning experience.

The personalized learning system 100 integrates social media-style features 304 into the user interface 104, such as vertical swipeable feeds with short educational content and interactive buttons like likes, dislikes, comments, shares, and bookmarks. The inclusion of media-style features into the user interface 104 aims to enhance user engagement similar to the engagement seen on social media platforms. The collector 124 then collects user engagement data 306 to track how users interact with the online learning platform 102. In operation 308, the user interaction data including likes, shares, comments, and bookmarks on various content feeds, is analyzed by an engagement analyzer 126 to understand user behavior and preferences.

Based on the analysis of data, the prompt generator 130 generates a prompt 310 to guide the AI engine 132. The prompt generated using a prompt generator 130 employs Natural Language Processing (NLP) techniques. The generated prompt guides the AI engine 132 to produce relevant content in correspondence to the user's interests (relevancy) and engagement score, which is estimated based on the mastery level of the user and the user engagement data 116.

The AI engine 132 processes the prompt and generates a personalized content feed 312, utilizing advanced AI and NLP algorithms to ensure the content is both engaging and educational. The generated content items are then displayed to the user 314 using the display module 146 on the social media-style user interface 104, providing an interactive and engaging learning experience.

Following the display, the personalized learning system 100 continuously monitors user actions 316, including interactions, engagement scores, and preferences. This data is used to dynamically adjust the user's learning path 318, ensuring it remains aligned with the evolving needs and goals of the user. Finally, a feedback loop is established where the updated engagement data is fed back 320 to the AI engine 132. This continuous feedback loop allows the personalized learning system 100 to refine and generate increasingly relevant content feed, maintaining high levels of user engagement and educational effectiveness.

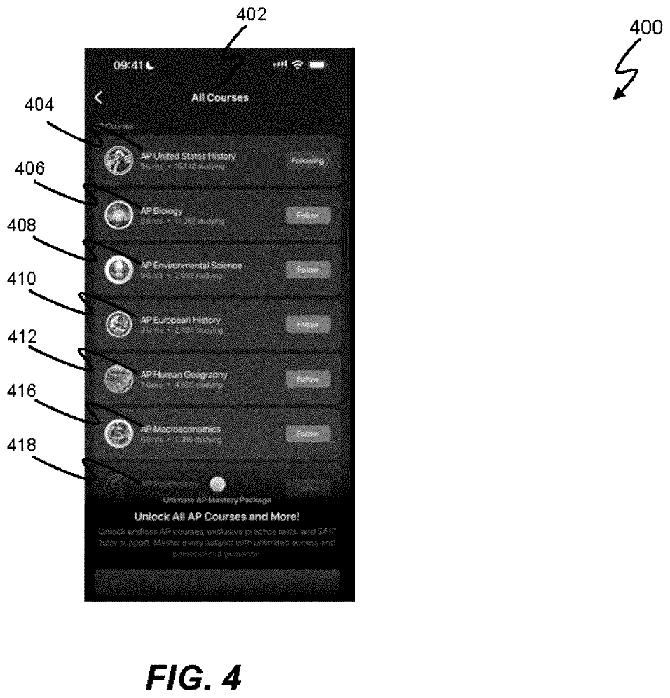

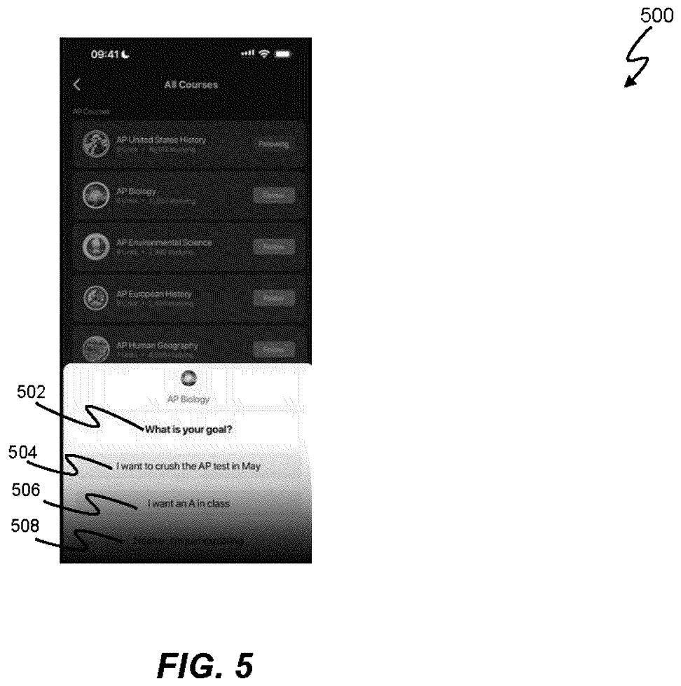

FIGS. 4 and 5 depict exemplary social media style user interfaces 400 and 500 disclosing courses offered to the user and the user's objective, selected by the user while using the online learning platform 102, respectively. The social media style user interfaces 400 and 500 can be accessed by the user through the online learning platform 102 using a user device. The user device may include any compatible device that has access to the online learning platform 102 like smartphones, tablets, computers, and so on.

The social media style user interface 400 discloses all the courses 402 available to the user on the online learning platform 102. As shown, the course 402 includes the AP (Advanced Courses) curriculum (in the case of the present example). Although there can be other curriculums like Common Core, NGSS, and so on that can be used to provide educational content to the user. As shown, various AP courses include ‘AP United States History’ 404, ‘AP Biology’ 406, ‘AP Environmental Sciences’ 408, ‘AP European History’ 410, ‘AP Human Geography’ 412, ‘AP Macroeconomics’ 416, and ‘AP Psychology’ 418. The user can click on the ‘Follow’ button in front of each course to follow the page of that particular course.

The social media style user interface 500 discloses the objective of user 502 for which the user is using the online learning platform 102. For instance, the user has selected the course ‘AP Biology’ 406 as shown in the user interface 400. After selecting the course, the user is asked to provide the goal or objective 502 for which he/she wants to study that course. For example, the goals or objectives may include ‘I want to crush the AP test in May’ 504, ‘I want an A grade in class’ 506, ‘Neither I am just exploring’ 508, and so on. The user can select whatever is the objective of the user behind accessing the online learning platform 102 and continue further.

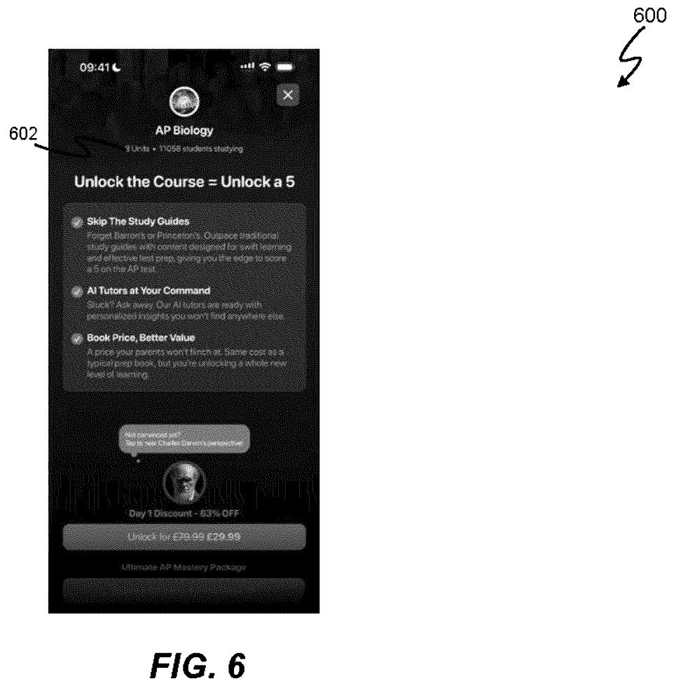

FIG. 6 depicts an exemplary social media style user interface 600 showing an option to unlock a course by making payment via the online learning platform 102. The social media style user interface 600 discloses the course 406 selected by the user. The user has selected the course ‘AP Biology’ 406 and the details of the same are provided to the user. For example, the course ‘AP Biology’ 406 has ‘8 units’ 602, and the number of users who are undergoing the same course ‘AP Biology’ 406. Further, the key benefits of using the online learning platform 102 are provided and the way to payment details are provided. The user can make the payment and access the course ‘AP Biology’ 406.

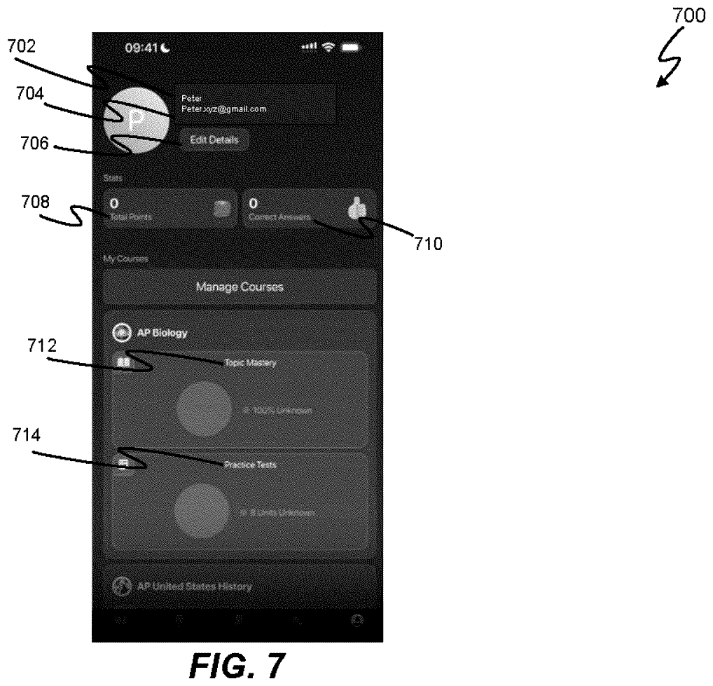

FIG. 7 depicts an exemplary social media style user interface 700 showing the user details and the course management options. The social media style user interface 700 shows the user profile details disclosing ‘User Name’ 702 and ‘email ID’ 704. The details can be modified by the user by clicking on the tab ‘Edit’ 706. Tabs 708 and 710 show ‘total points collected’ by the user while answering the questions and ‘total correct answers’ provided by the user during the tests, MCQs, and quizzes respectively.

Further, the user can manage the selected courses by choosing whether he/she is interested in mastery of the subject or giving tests. For example, if the user has selected the course ‘AP Biology’ 406. Now if the user wants to gain mastery in the course by learning all the topics within the course, then the user will click on tab 712 ‘Topic Mastery’, where the user will be given access to the educational content generated by the AI engine 132. But if the user has already knowledge about all the topics and the main objective of the user is to assess himself/herself, then the user will click on tab 714 ‘Practice Tests’, where the user will get access to the tests, assessments, and so on based on which the user can know the areas where he/she is lacking and needs more attention.

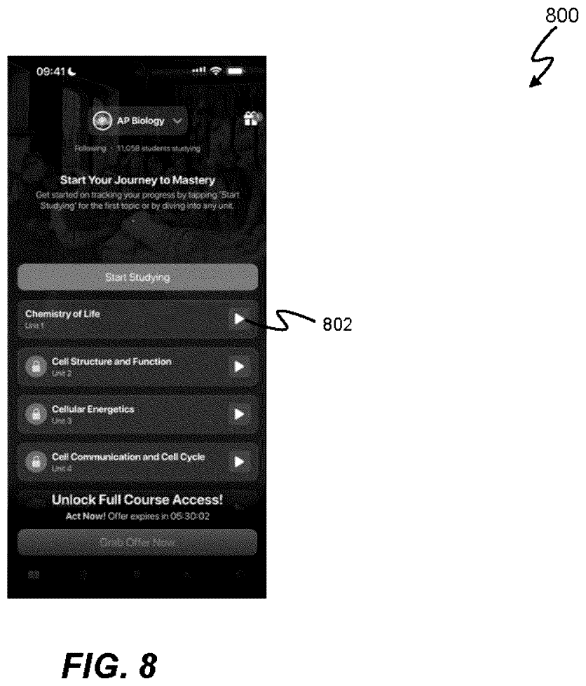

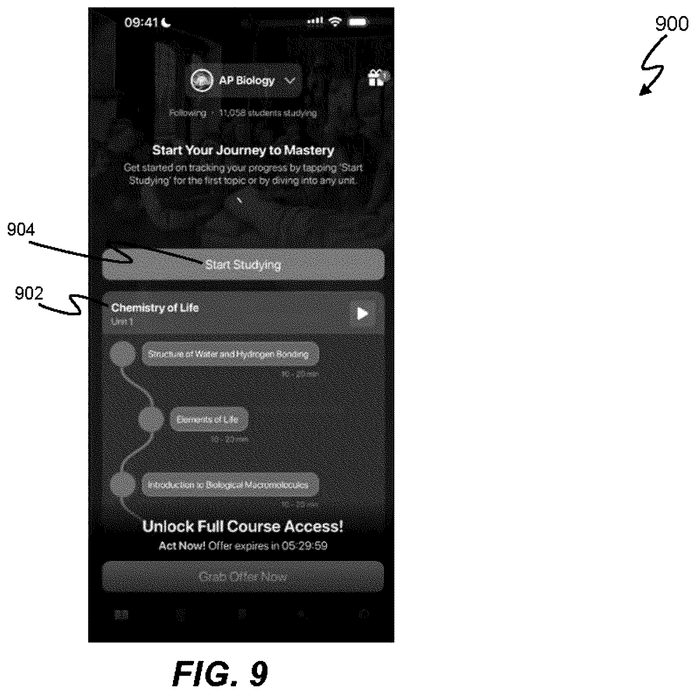

FIGS. 8 and 9 depict exemplary social media style user interfaces 800 and 900 disclosing the unit-wise and topic-wise details of the educational content displayed to the user using the online learning platform 102. The user interface 800 shows different units under the selected course. For example, if the user has selected the course ‘AP Biology’ 406, the different units within the course will be shown to the user. The user can click on the triangular button 802 placed in front of each unit to access that unit.

The user interface 900 shows different topics under the selected unit. For example, suppose the user has selected ‘Unit-1 Chemistry of Life’ 902 from the Course ‘AP Biology’ 406, the topics under the selected ‘Unit-1 Chemistry of Life’ 902 will appear on the user interface 900. The user can access the topic which he/she wishes to learn by clicking on tab 904 ‘Start Studying’. The circle in front of every topic depicts the mastery level of the user in that particular topic which is calculated based on the correct answer provided by the user during the learning session.

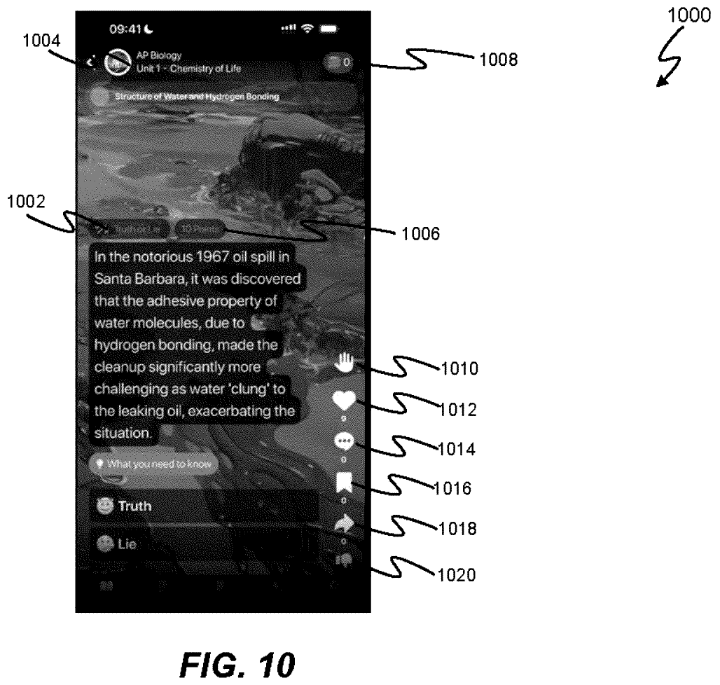

FIG. 10 depicts an exemplary social media style user interface 1000 showing the generated content item for the user using the online learning platform 102. The social media style user interface 1000 shows the question asked to the user in the form of ‘Truth or Lie’ 1002. The Course name and the Unit name i.e., AP Biology and Unit-1-Chemistry for Life 1004 are given at the top of the user interface 1000. The topic i.e., Structure of water and hydrogen bonding 1004 depicts the topic selected by the user. The points 1006 allocated to question 1002 are mentioned above the question. The total points collected by the user 1008 is shown at the top right corner of the user interface 1000. As soon as the user gives the correct answer the points allotted for each question 1006 get added to the total points 1008.

The user interface 1000 has various interactive elements integrated within it to mimic the social media platform style. This includes buttons like ‘Hand Raise’ 1010, ‘Like’ 1012, ‘Comment’ 1014, ‘Bookmark’ 1016, ‘Share’ 1018, and ‘Dislike’ 1020. These interactive buttons work similarly to that of the social media platform. For example, the user can click on the button ‘Hand Raise’ 1010 to raise a query and the user can interact with the real-time AI tutor to solve his/her query. Similarly, the user can like, comment, bookmark, share, or dislike the content item feed provided to the user using the interactive buttons ‘Like’ 1012, ‘Comment’ 1014, ‘Bookmark’ 1016, ‘Share’ 1018, and ‘Dislike’ 1020 respectively in a similar manner like that of the social media platform. This makes the learning very engaging and attractive to the user.

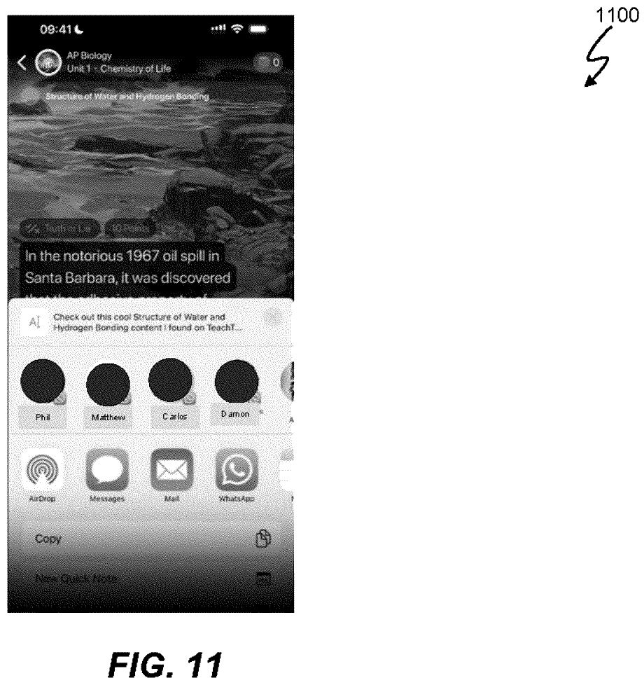

FIG. 11 depicts an exemplary social media style user interface 1100 showing the sharing of the content feed to other users. The user interface 1100 shows that the user can share the content item feed to any other user like the way it is done on a social media platform. The user can click on tab 1018 and share the content item feed via various social media platforms like WhatsApp, Telegram, Gmail, Messenger, Instagram Chats, and so on to the other user.

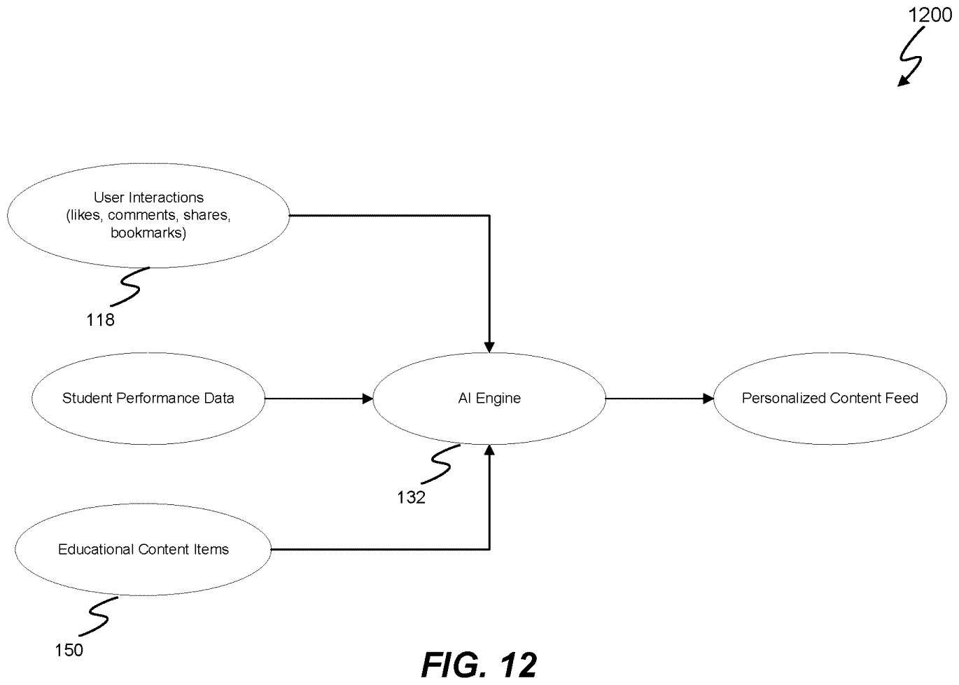

FIG. 12 depicts a personalized content feed generation process 1200, which is an embodiment of the personalized learning process 200 using a social media style user interface 104 of FIG. 2. The personalized content feed generation process 1200 describes how the personalized content items feeds are generated and delivered to users by utilizing user interactions 118, user engagement details 116, and educational content items 150. The user interactions 118 capture the actions users perform within the online learning platform 102, such as liking, commenting, sharing, and bookmarking content items. These interactions serve as valuable indicators of user preferences and engagement levels. The user engagement details 116 includes data related to users' academic performance, such as quiz scores, test or session completion rates, and so on in various subjects. The user engagement details 116 provides insights into users' strengths and weaknesses. The educational content item 150 comprises a diverse range of educational materials, including articles, videos, quizzes, and other learning resources. It serves as the source of content that can be recommended to users based on their preferences and learning objectives.

The data from user interactions 118, user engagement details 116, and educational content items 150 is passed on to the AI engine 132 via the engagement and mastery analyzer 120 (not shown in the figure). The prompt generator 130 (not shown in the figure) generates the prompts and transfers them to the AI engine 132. The AI engine 132 utilizes the AI NLP techniques to generate personalized content items feed for the user based on the engagement score of the user and the relevancy of the content item with respect to the user's preferences. The AI engine 132 generates the content item feed and displays it to the user on the social media style user interface 104. The generated content items feed gets dynamically updated on a real-time basis to provide updated content to the user and meet the changing requirements of the user over time.

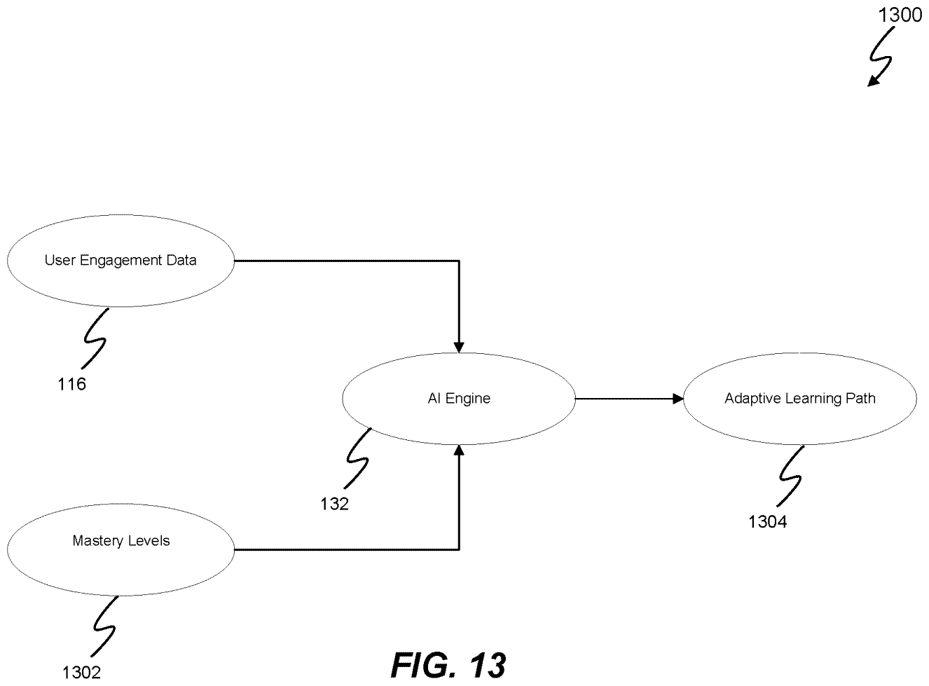

FIG. 13 depicts a customized learning path generation process 1300, which is an embodiment of the personalized learning process 200 using a social media style user interface 104 of FIG. 2. The customized learning path generation process 1300 illustrates the workflow designed to personalize the educational experience for users by utilizing user engagement details 116 and mastery levels to create an adaptive learning path. The user engagement details 116 store data on how users interact with the content items feed which includes metrics such as likes, comments, shares, and bookmarks. The user engagement details 116 provide insights into what type of content the user finds interesting and engaging. By analyzing this data, the personalized learning system 100 can utilize user preferences and content to maintain high levels of user engagement. The mastery level 1302 represents the proficiency and understanding that users have achieved in various subjects or topics. Mastery levels 1302 are determined through tests, quizzes, MCQs, and other evaluative methods that measure user performance. By utilizing the mastery level 1302 of the user, the personalized learning system 100 identifies areas where a user excels or struggles, which is essential for customizing the learning path in correspondence to the user to address individual and fulfill user learning requirements.

The data from user engagement details 116 and mastery level 1302 is passed on to the AI engine 132 which is used for analyzing the input from both user engagement details 116 and mastery level 1302. The AI engine 132 utilizes AI NLP techniques using the AI NLP 134 (not shown in the figure) to process this data. The AI engine 132 personalizes the content item feed for each user based on the preferences and relevancy of each user, thereby creating a personalized learning experience for each user. By combining user engagement details 116 and mastery levels 1302, the AI engine 132 can recommend content item feed to the user that is both interesting and appropriately challenging, ensuring that users remain engaged and can make meaningful progress in their learning.

Finally, an adaptive learning path 1304 is generated using the path generator 138 (not shown in the figure), integrated within the AI NLP 134 of the AI engine 132. The adaptive learning path 1304 is a dynamically generated sequence of content items generated in correspondence to the individual user's needs. The adaptive learning path 1304 adapts in real-time as more user engagement details 116 and mastery levels 1302 are collected, continuously refining and optimizing the learning journey. This ensures that users receive content that is relevant to the user's interests and appropriate for their skill level.

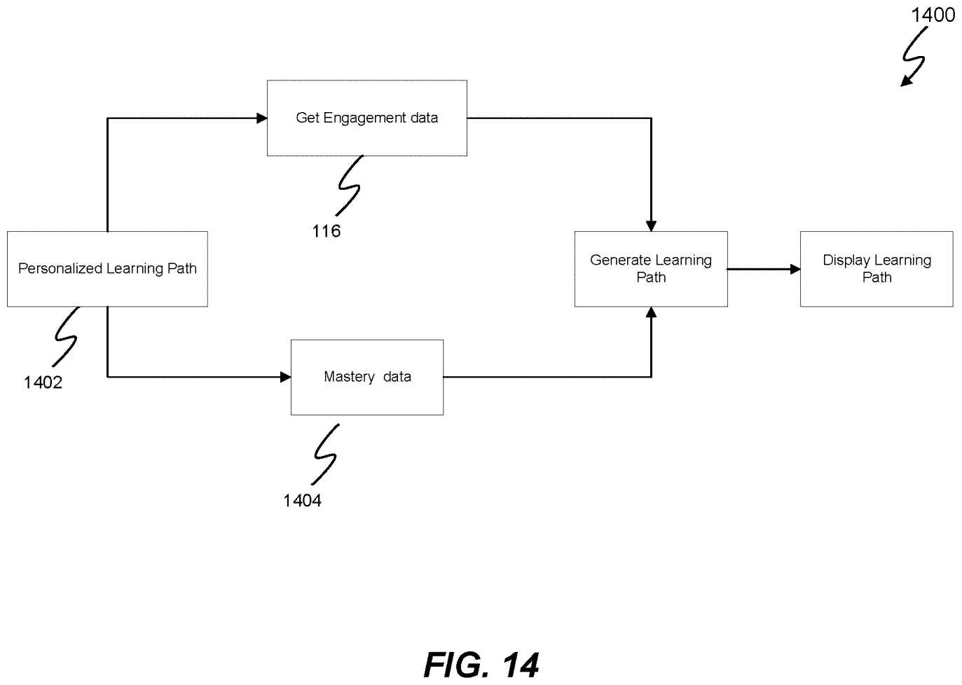

FIG. 14 depicts a learning path display process 1400, which is an embodiment of the personalized learning process 200 using a social media style user interface 104 of FIG. 2.

The learning path display process 1400 personalizes educational content items 150 by generating a personalized learning path 1402 based on user engagement details 116 and mastery data 1404. The personalized learning path 1402 marks the initial phase in the process of crafting a personalized learning journey for each user. The personalized learning path 1402 is generated using a path generator 138 (not shown in the figure) integrated within the AI NLP 134 of the AI engine 132. The user interaction 118 collects the data from the online learning platform 102 which includes metrics such as likes, comments, shares, and bookmarks. The user engagement details 116 is essential for understanding what types of content the user finds interesting and engaging. By gathering this information, the personalization learning system 100 can make the learning experience of the user engaging. The mastery data 1404 is obtained through tests, quizzes, MCQs, and other evaluative tools that measure how well the user understands the educational content item 150. The mastery data 1404 data helps identify areas where the user excels and areas that require more attention, thereby highlighting the areas where more attention is required from the user side to attain the mastery in that particular educational content item 150.

The data collected from the user engagement details 116 and mastery data 1404 is utilized by the path generator 138 (not shown in the figure) integrated within the AI NLP 134 of the AI engine 132 to generate a learning path 1406. The AI engine 132 utilizes AI NLP techniques using the AI NLP 134 (not shown in the figure) to process this data. The AI engine 132 personalizes the content item feed for each user based on the preferences and relevancy of each user, thereby creating a personalized learning experience for each user. By combining user engagement details 116 and mastery data 1404, the AI engine 132 can recommend content item feed to the user that is both interesting and appropriately challenging, ensuring that users remain engaged and can make meaningful progress in their learning. The personalized learning path 1406 is generated using the path generator 138 (not shown in the figure), integrated within the AI NLP 134 of the AI engine 132. The adaptive learning path 1304 is a dynamically generated sequence of content items in correspondence to the individual user's needs. The personalized learning path 1406 adapts in real-time as more user engagement details 116 and mastery data 1404 are collected, continuously refining and optimizing the learning journey.

Finally, the content items feed is displayed to the user on the social media style user interface 104 (not shown in the figure) using a display module 146 (not shown in the figure) which personalizes and adjusts the sequence of the content items feed. The personalized learning path 1406 keeps updating over time on a real-time basis based on which the content items feed is updated to provide an enhanced and engaging experience to the user.

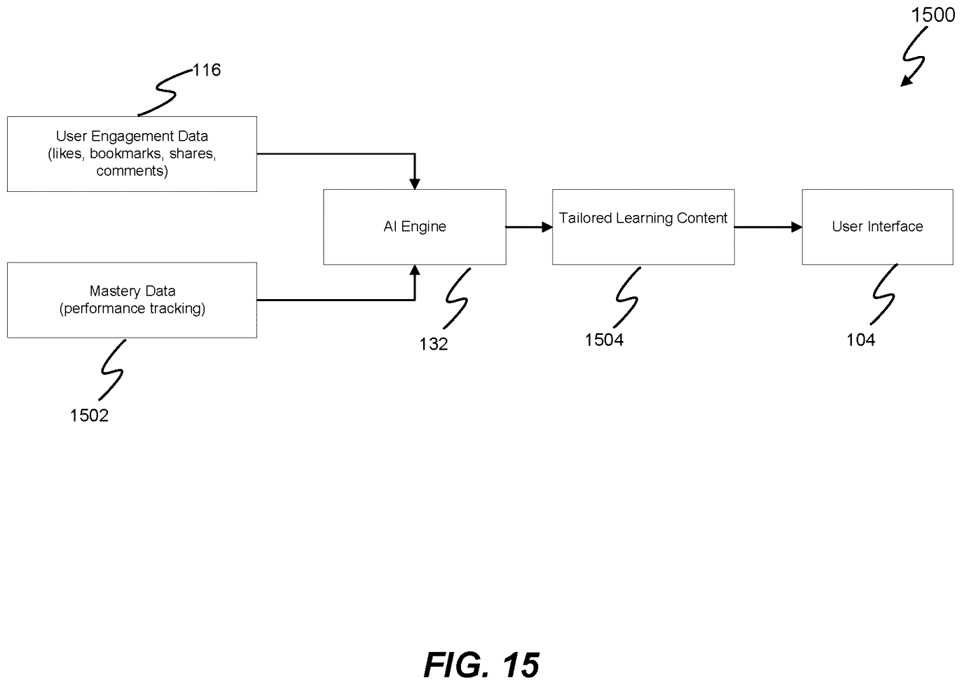

FIG. 15 depicts an adaptive and personalized learning content item display process 1500 on the social media style user interface 104, which is an embodiment of the personalized learning process 200 using the social media style user interface 104 of FIG. 2.

The adaptive and personalized learning content items display process 1500 illustrates the use of AI engine 132 that utilizes user engagement details 116 and mastery data 1502 to generate the content feed items 1504 and display it to the user on the social media style user interface 104. The user interaction 118 collects the data from the online learning platform 102 which includes metrics such as likes, comments, shares, and bookmarks. The user engagement details 116 is essential for understanding what types of content the user finds interesting and engaging. By gathering this information, the adaptive and personalized learning content items display process 1500 can make the learning experience of the user engaging. The mastery data 1502 is obtained through tests, quizzes, MCQs, and other evaluative tools that measure how well the user understands the educational content item 150. The mastery data 1502 data helps identify areas where the user excels and areas that require more attention, thereby highlighting the areas where more attention is required from the user side to attain mastery in that particular educational content item 150.

The data collected from the user engagement details 116 and mastery data 1502 is utilized by the path generator 138 (not shown in the figure) integrated within the AI NLP 134 of the AI engine 132 to generate a learning path. The AI engine 132 utilizes AI NLP techniques using the AI NLP 134 (not shown in the figure) to process this data. The AI engine 132 personalizes the content item feed 1504 for each user based on the preferences and relevancy of each user, thereby creating a personalized learning experience for each user. By combining user engagement details 116 and mastery data 1502, the AI engine 132 can recommend content item feed 1504 to the user that is both interesting and appropriately challenging, ensuring that users remain engaged and can make meaningful progress in their learning. The adaptive learning path is a dynamically generated sequence of content items generated in correspondence to the individual user's needs. The personalized learning path adapts in real-time as more user engagement details 116 and mastery data 1502 are collected, continuously refining and optimizing the learning journey.

Finally, the content items feed 1504 is displayed to the user on the social media style user interface 104 (not shown in the figure) using a display module 146 (not shown in the figure) which personalizes and adjusts the sequence of the content items feed 1504. The content items feed 1504 keeps on updating overtime on a real-time basis based on the user interactions 118 with the online learning platform 102, preferences of the user, and user engagement details 116, thereby providing the relevant content items feed 1504 to the user.

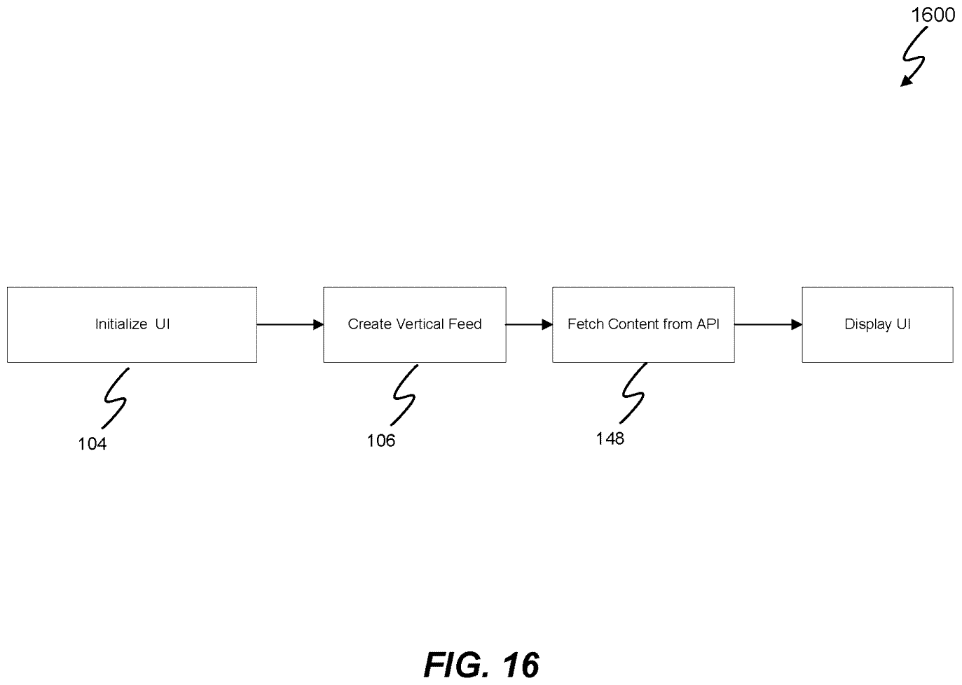

FIG. 16 depicts a social media style user interface 104 initialization process 1600, which is an embodiment of the personalized learning process 200 using a social media style user interface 104 of FIG. 2.

The social media style user interface 104 initialization process 1600 explains the initialization of the user interface 104. The social media style user interface 104 is initialized by creating a swipeable vertical feed 106 within the social media style user interface 104 to display content items to the user. For creating a swipeable vertical feed 106 the initialization of an empty list is done to hold the educational content items 150. Following this initialization, the educational content items 150 are fetched from an external source through API 152 (Application Programming Interface), and subsequently, the list is populated with the retrieved educational content items 150. The educational content items 150 are fetched from the API 152 including sending a request from the user side via the online learning platform 102 to the engagement and mastery analyzer 120 via the API 152 to retrieve the educational content items 150. The educational content item 150 is received from the engagement and mastery analyzer 120 via the API 152 and is provided to the user interface 104 in a format compatible with the user interface 104. The educational content items 150 undergo processing using AI engine 132 to generate the content items that are in correspondence to the user's needs.

Once populated, the educational content items 150 are then reduced and showcased in a vertically swipeable feed 106 integrated within the social media style user interface 104. This allows the user to experience the familiar browsing experience seen in popular social media platforms, thereby enhancing user engagement. Furthermore, to increase user interaction 118 and engagement, interactive buttons such as like, dislike, comment, share, and bookmark buttons are embedded alongside each content item within the swipeable vertical feed 106.

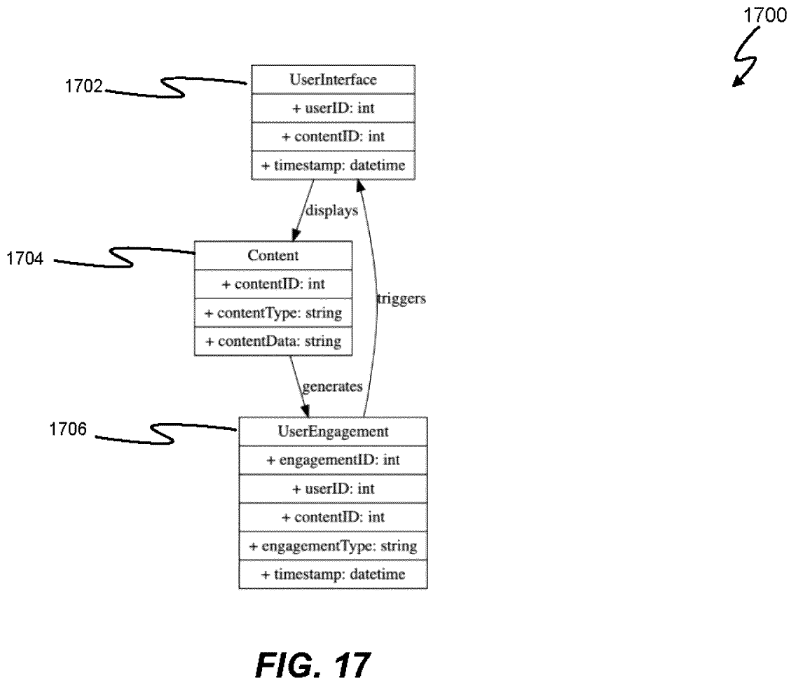

FIG. 17 depicts a data structure 1700 for organizing data that is used to utilize a social media style user interface 104 for user engagement.

The data structure 1700 described in FIG. 17 illustrates the relationships and interactions between different components within a social media-style user interface 104 designed for the online learning platform 102. The data structure 1700 involves three main entities namely, the User Interface 1702, Content 1704, and User Engagement 1706, each with specific attributes and roles.

The UserInterface node 1702 represents the social media style user interface 104 through which users interact with the educational content items 150. The UserInterface node 1702 includes attributes such as userID, contentID, and timestamp. These attributes respectively identify the user interacting with the content items, the specific content items being displayed, and the time at which the interaction takes place. This node functions as the medium for displaying content to the user and logging the interaction details.

The Content node 1704 refers to the educational content items 150 available on the online learning platform 102. This node includes attributes such as contentID, contentType, and contentData. contentID uniquely identifies each piece of content, contentType specifies the nature of the content (e.g., video, text, quiz), and contentData holds the actual content itself. This node is crucial as it provides the educational content items 150 that users engage with.

The UserEngagement node 1706 captures the interactions users have with the content items displayed on the online learning platform 102. The UserEngagement node 1706 includes attributes like engagementID, userID, contentID, engagementType, and timestamp. The engagementID uniquely identifies each engagement instance, userID and contentID link the engagement to specific users and content, engagementType describes the nature of the interaction (e.g., like, comment, share, bookmark), and timestamp records when the engagement occurred. This node is essential for understanding user behavior and preferences.

The relationships between these nodes are represented by directed edges. For example, the edge from UserInterface 1702 to Content 1704 is labeled as ‘displays’, which indicates that user interface 104 displays content items to the user. Further, the edge from UserEngagement 1706 to UserInterface 1702 is labeled as ‘triggers’ which signifies that user interactions on the user interface 104 triggers engagement events, and finally the edge from Content 1704 to UserEngagement 1706 is labeled as ‘generates’ which shows that the content items displayed to users generate engagement data when users interact with it.

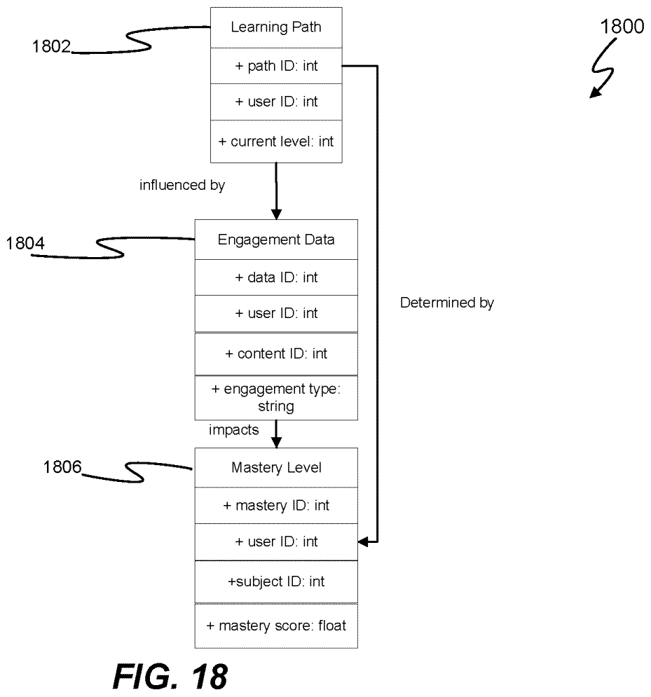

FIG. 18 depicts a data structure 1800 for organizing data that is used to generate an adaptive learning path for personalizing the learning path of each user using the online learning platform 102.

The data structure 1800 described in FIG. 18 represents the necessary user interactions for personalizing an educational learning path based on user engagement and mastery levels. The data structure 1800 includes three primary entities namely, Learning Path 1802, Engagement Data 1804, and Mastery Level 1806, each with specific attributes and roles.

The LearningPath node 1802 represents the personalized educational journey for a user using the online learning platform 102. The LearningPath node 1802 includes attributes such as pathID, userID, and currentLevel. The pathID uniquely identifies each learning path, userID links the path to a specific user, and currentLevel indicates the user's current progress within the learning path. The LearningPath node 1802 makes the content items with respect to the user's needs.

The EngagementData node 1804 captures the details of the user's interactions 118 with the content items. The EngagementData node 1804 includes attributes like dataID, userID, contentID, engagementType, and timestamp. The dataID uniquely identifies each engagement record, userID and contentID link the engagement to specific users and content, engagementType describes the nature of the interaction (e.g., like, comment, share, bookmark), and timestamp records when the engagement occurred. The EngagementData node 1804 understands user behavior and preferences, providing insights into how users interact with educational content 150.

The MasteryLevel node 1806 assesses the user's proficiency in various subjects. The MasteryLevel node 1806 includes attributes such as masteryID, userID, subjectID, and masteryScore. The masteryID uniquely identifies each mastery record, userID links the mastery data to a specific user, subjectID specifies the subject being assessed, and masteryScore quantifies the user's proficiency level. The MasteryLevel node 1806 helps identify areas where the user excels or needs improvement.

The relationships between these nodes are depicted by directed edges. For example, the edge from LearningPath 1802 to EngagementData 1804 is labeled as ‘influenced by’ which indicates that the learning path is influenced by the user's engagement data. Further, the edge from LearningPath 1802 to MasteryLevel 1806 is labeled as ‘determined by’ which signifies that the learning path is determined by the user's mastery levels and finally the edge from EngagementData 1804 to MasteryLevel 1806 is labeled as ‘impacts’ shows that the engagement data impacts the assessment of the user's mastery levels.

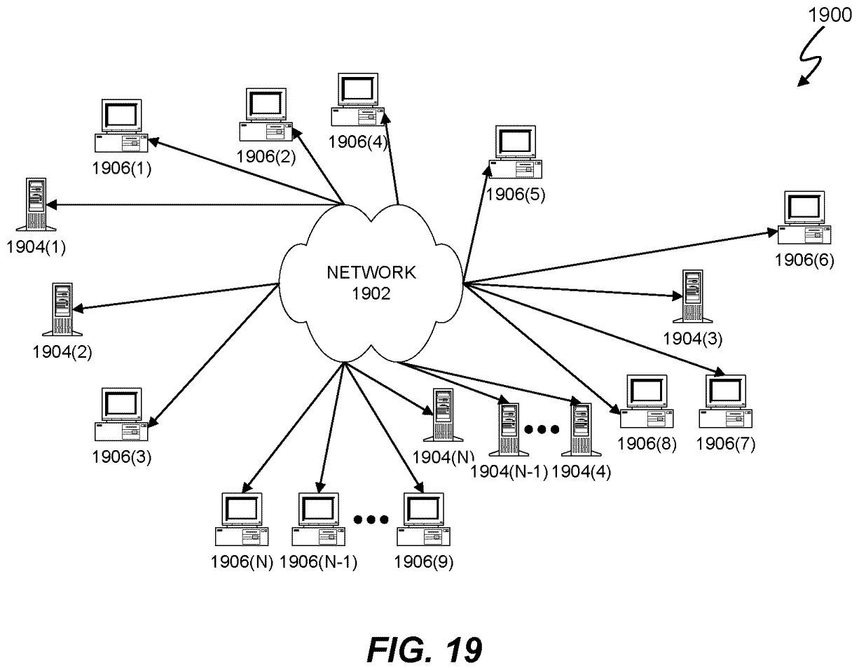

FIG. 19 is a block diagram illustrating a network environment in which a personalized learning system 100 and personalized learning process 200 using a social media style user interface may be practiced. Network 1902 (e.g. a private wide area network (WAN) or the Internet) includes several networked server computer systems 1904(1)-(N) that are accessible by client computer systems 1906(1)-(N), where N is the number of server computer systems connected to the network. Communication between client computer systems 1906(1)-(N) and server computer systems 1904(1)-(N) typically occurs over a network, such as a public switched telephone network over asynchronous digital subscriber line (ADSL) telephone lines or high-bandwidth trunks, for example, communications channels providing T1 or OC3 service. Client computer systems 1906(1)-(N) typically access server computer systems 1904(1)-(N) through a service provider, such as an internet service provider (“ISP”) by executing application-specific software, commonly referred to as a browser, on one of client computer systems 1906(1)-(N).

Client computer systems 1906(1)-(N) and/or server computer systems 1904(1)-(N) are specialized computers programmed to improve conventional computer systems to implement and utilize the personalized learning system 100 and personalized learning process 200 using a social media style user interface. The type of computer system that can be specially programmed to implement and utilize the personalized learning system 100 and personalized learning process 200 using a social media style user interface includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the personalized learning system 100 and personalized learning process 200 using a social media style user interface can be implemented using code stored in a tangible, non-transient computer-readable medium and executed by one or more processors. In at least one embodiment, the personalized learning system 100 and personalized learning process 200 using a social media style user interface can be implemented completely in hardware using, for example, logic circuits and other circuits including field programmable gate arrays.

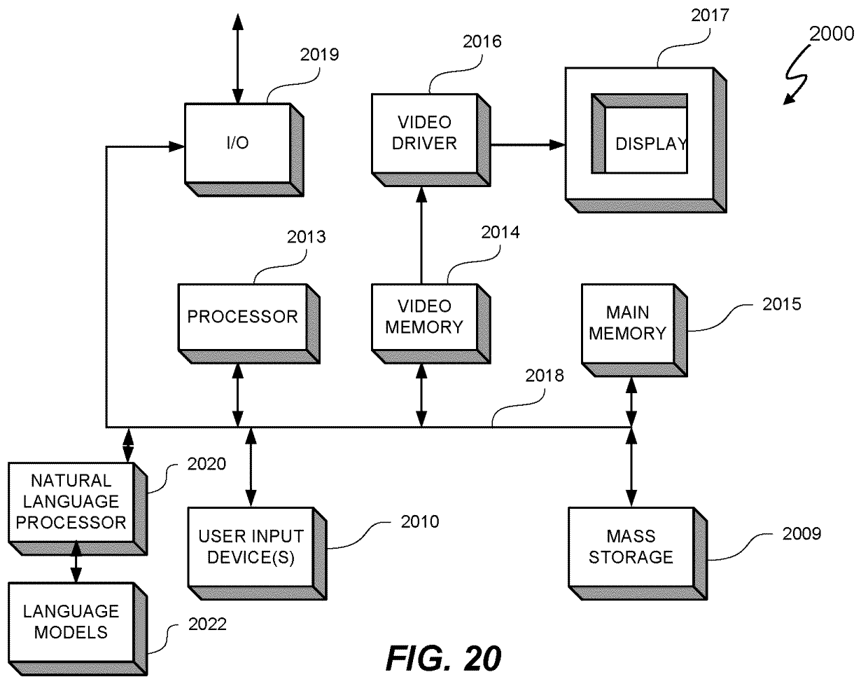

Embodiments of the personalized learning system 100 and personalized learning process 200 using a social media style user interface can be implemented on a computer system such as a special-purpose, special-programmed computer 2000 illustrated in FIG. 20. The input user device(s) 2010, such as a keyboard and/or mouse, are coupled to a bi-directional system bus 2018. The input user device(s) 2010 are for introducing user input to the computer system and communicating that user input to the processor 2013. The computer system of FIG. 20 generally also includes a non-transitory video memory 2014, non-transitory main memory 2015, and non-transitory mass storage 2009, all coupled to the bi-directional system bus 2018 along with input user device(s) 2010 and processor 2013. The mass storage 2009 may include both fixed and removable media, such as a hard drive, one or more CDs or DVDs, solid state memory including flash memory, and other available mass storage technology. Bus 2018 may contain, for example, 32 of 64 address lines for addressing video memory 2014 or main memory 2015. The system bus 2018 also includes, for example, an n-bit data bus for transferring DATA between and among the components, such as CPU 2009, main memory 2015, video memory 2014, and mass storage 2009, where “n” is, for example, 32 or 64. Alternatively, multiplex data/address lines may be used instead of separate data and address lines.

I/O device(s) 2019 may provide connections to peripheral devices, such as a printer, and may also provide a direct connection to a remote server computer system via a telephone link or to the Internet via an ISP. I/O device(s) 2019 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2009, into main memory 2015 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2015 consists of dynamic random access memory (DRAM). Video memory 2014 is a dual-ported video random access memory. One port of the video memory 2014 is coupled to the video amplifier 2016. The video amplifier 2016 is used to drive the display 2017. Video amplifier 2016 is well-known in the art and may be implemented by any suitable means. This circuitry converts pixel DATA stored in video memory 2014 to a raster signal suitable for use by display 2017. Display 2017 is a type of monitor suitable for displaying graphic images.

The computer system described above is for purposes of example only. The personalized learning system 100 and personalized learning process 200 using a social media style user interface may be implemented in any type of computer system or programming or processing environment. It is contemplated that personalized learning system 100 and personalized learning process 200 using a social media style user interface might be run on a stand-alone computer system, such as the one described above. The personalized learning system 100 and personalized learning process 200 using a social media style user interface might also be run from a server computer system that can be accessed by a plurality of client computer systems interconnected over an intranet network. Finally, the personalized learning system 100 and personalized learning process 200 using a social media style user interface may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method for providing educational content to a user using a social media style user interface comprising:
executing code using one or more processors of a computer system to cause the computer system to perform operations comprising:
integrating social media style user interface to an online learning platform for enhancing user engagement by including short content feed that are displayed to the user in the form of a swipeable vertically browsing content item and incorporating buttons like liking, disliking, commenting, sharing, and bookmarking for providing an interaction between the user and the user interface;
accessing one or more user profile details available in a user profile and collecting the one or more user profile details and user engagement data, wherein the one or more user profile details include user preferences, interests, historical data, educational goals, and topics of interest;
providing a customized content feed to the user by analyzing user engagement data and student performance to determine engagement patterns and mastery levels of the user;
generating a customized learning path for each user based on the engagement patterns and mastery levels and identifying content feed for each user based on the highest engagement score, wherein the engagement score is determined using frequency and type of the user engagement data; and
receiving the customized content feed that has a higher engagement score, wherein the content that is highly engaging in the user's content feed are prioritized during the display.

2. The method of claim 1 wherein the user engagement data includes user actions including likes, bookmarks, shares, dislikes, and comments on the content displayed to the user on the social media style user interface.

3. The method of claim 1 wherein the calculation of the engagement score comprises:
monitoring user actions including likes, dislikes, bookmarks, shares, and comments on content feed provided to the user on the social media style user interface of the online learning platform;
recording the frequency and type of the user actions for each content item feed;
assigning weights to different types of user actions based on their impact on user engagement; and
adjusting the weights dynamically based on the historical user engagement data and user feedback.

4. The method of claim 1 wherein the frequency and recency of the user actions with the content item feeds are analyzed to assess the engagement level of the user.

5. The method of claim 4 wherein the recency of the user actions is determined based on the time elapsed since the last interaction of the user with the user interface.

6. The method of claim 1 wherein creating a vertical feed to display the content to the user comprises:
initializing an empty list to hold the content items;
fetching the educational content items from API and populating the list using the educational content items;
displaying the educational content items in a vertically swipeable feed in the social media style user interface; and
incorporating interactive buttons such as like, dislike, comment, share, and bookmark buttons for each content item in the vertical feed to enhance user engagement.

7. The method of claim 1 wherein machine learning algorithms are used to determine the engagement score and the mastery level comprises:
applying machine learning algorithms to historical user actions, including likes, dislikes, comments, shares, and bookmarks for identifying patterns of user engagement with the content feed;
machine learning techniques to assess user mastery levels based on performance metrics such as quiz scores, completion rates, and proficiency in specific educational topics or skills;
utilizing the insights for generating the prompt for the AI engine to create the customized learning path for each user; and
identifying content feed for each user based on the highest engagement score and transferring this information to the AI engine for content recommendation.

8. The method of claim 1 wherein the difficulty levels and topic to be focused is customized and changed based on the user's learning requirements including the user's mastery level, learning goals, and user's performance in content item feeds.

9. The method of claim 1 utilizes machine learning algorithms to refine the customized learning path content recommendations.

10. The method of claim 1 wherein the personalized content feed displayed to the user comprises:
prioritizing the content with the highest engagement score in the user's feed; and
adjusting the display order of the content based on the user's recent interactions to maintain high levels of engagement.

11. The method of claim 1 wherein a feedback loop incorporates sentimental analysis of user actions on the content feed comprises:
utilizing NLP techniques to analyze the sentiments expressed by the user in the comments, likes, sharing, and dislikes of the content item feed;
generating insights based on the analysis of the user actions; and
incorporating the insights to provide relevant content to the user using the AI engine.

12. A system to provide educational content to a user through a social media style user interface comprises:
one or more processors;
a memory, coupled to the one or more processors, storing code that when executed cause the one or more processors to perform operations comprising:
integrating social media style user interface to an online learning platform for enhancing user engagement by including short content feed that are displayed to the user in the form of a swipeable vertically browsing content item and incorporating buttons like liking, disliking, commenting, sharing, and bookmarking for providing an interaction between the user and the user interface;
accessing one or more user profile details available in a user profile and collecting the one or more user profile details and user engagement data, wherein the one or more user profile details include user preferences, interests, historical data, educational goals, and topics of interest;
providing a customized content feed to the user by analyzing user engagement data and student performance to determine engagement patterns and mastery levels of the user;
generating a customized learning path for each user based on the engagement patterns and mastery levels and identifying content feed for each user based on the highest engagement score, wherein the engagement score is determined using frequency and type of the user engagement data; and
receiving the customized content feed that has a higher engagement score, wherein the content that is highly engaging in the user's content feed are prioritized during the display.

13. The system of claim 12 wherein the social media style user interface further comprises:
a design mimicking social media platforms featuring swipeable vertically browsing content and interactive buttons for liking, disliking, commenting, sharing, and bookmarking the content feed displayed to the user.

14. The system of claim 12 wherein the prompt generation using the prompt generator comprises:
analysis of user actions, including, likes, dislikes, comments, shares, and bookmarks to identify patterns of user engagement with the content feed; and
evaluation of user's performance based on quiz scores and completion rate, to determine the mastery level of the user in each topic.

15. The system of claim 12 wherein the prompt generator can dynamically adjust the prompt generation based on real-time user interaction and feedback to ensure relevance and effectiveness in guiding the AI engine.

16. The system of claim 12 wherein the social media style user interface is integrated within the online learning platform to seamlessly provide the content feed generated by the AI engine to the user using the online learning platform.

17. The system of claim 12 further comprises:
a monitor to monitor each user engagement trend over a period of time to identify changes in user behavior and preferences; and
a predictor to utilize machine learning algorithms to forecast future user engagement patterns and adapt content delivery strategies accordingly.

18. The system of claim 12 utilizes a path generator for generating a personalized path for each user comprises:
analyze the user's current mastery levels across various educational topics by evaluating quiz scores, test completion rate, time taken while answering each question, time taken during each session, and so on;
incorporate user preferences and interests that the user finds most interesting;
adjusting the difficulty level of the content based on the user's progress and performance, ensuring the content remains challenging yet achievable; and
continuously updating the learning path in real-time based on ongoing user interactions and feedback to ensure the content remains relevant and engaging.

19. The system of claim 12 wherein the personalized content item feed is displayed to the user using a display module that prioritizes the content with the highest engagement score in the user's feed and dynamically adjusts the display order of the content based on the user's recent interactions to maintain high levels of engagement.

20. The system of claim 12 further comprises:
a feedback module that allows users to provide feedback directly within the social media style user interface, promoting user engagement.
